(19) United States
(12) Patent Application Publication
(10) Pub. No.: US 2003/0131919 A1
(43) Pub. Date: Jul. 17, 2003

(54) Method for simultaneously imprinting a pattern and bonding cellulose webs using ultrasonic energy

(76) Inventors: Timothy James King, Carnsforth (GB); Cheryl Lynn York, Alpharetta, GA (US)

Correspondence Address: KIMBERLY-CLARK WORLDWIDE, INC., 401 NORTH LAKE STREET, NEENAH, WI, 54956

(21) Appl. No.: 10/035,067

(22) Filed: Dec. 28, 2001

(51) Int. Cl. B31F 1/00

(52) U.S. Cl. 156/73.1; 156/209

(57) ABSTRACT

A method of simultaneously laminating and imprinting a pattern on a web formed substantially from cellulosic material, using at least two plies or layers, and superposing the plies and passing the plies past an ultrasonic bonder and a patterned anvil roll to simultaneously produce either substantially imprinted patterned and bonded areas over the superposed plies or substantially patterned perforations and bonded areas over the superposed plies.

### FIELD OF THE INVENTION

This invention generally relates to the field of imprinting and joining fibrous cellulose webs together, and more particularly, to simultaneous ultrasonic imprinting of a pattern and sonic bonding of cellulose webs.

### BACKGROUND

Cellulose webs often have two or more plies, and the plies are bonded together by various means. In some instances, the plies are bonded together by an apparatus which crimps the plies into a cellulosic laminate. Often, it is desirable to bond the cellulosic plies and to simultaneous provide a pattern upon the cellulosic laminate as well. One such apparatus and process for producing a crimp-bonded and patterned cellulosic laminate is disclosed in U.S. Pat. No. 5,622,734. In this instance, two or more plies are bonded together simultaneously when the web is run through mechanical crimping wheels that apply high pressure to the two or more plies of the web in order to bond the web together, and in some instances, also impart a portion of a pattern such as a linear edge crimp or an overall pattern, at the same time. This technique, however, has disadvantages. At higher converting speeds, the crimping wheels will sometimes skip and miss a portion of the web, resulting in inconsistent and indistinguishable printing/imprinting of the pattern, uneven ply attachment, or the absence of either of the latter, or both, in some areas.

Cellulose webs have been bonded together in other ways. Ultrasonic energy has been used to “stitch” or bond two or more webs together, but has required the use of a significant amount of adhesive as well, as disclosed in U.S. Pat. No. 3,660,186. Ultrasonic energy is well known for bonding as well as applying patterns to heavier basis weight nonwoven fabrics made from thermoplastic fibers. One such method of bonding such nonwoven webs, which uses a liquid to moisten the material just prior to bonding, is disclosed in U.S. Pat. No. 4,605,454. The addition of adhesives and/or fluids may not be suitable for personal care tissue products because physical properties of the tissue products such as softness, bulk, and absorption may be compromised, and such addition may add further expense to the manufacturing process.

Previously, when ultrasound energy has been used on webs comprising primarily, or exclusively, cellulosic material, the webs were often burned when attempts were made to both provide a laminate as well as a pattern simultaneously. While some bonding was possible, bonding while simultaneously providing a significant pattern caused burning and degradation of the web, and making the web unfit for sale or use. Even when ultrasonic energy was successful in providing a degree of bonding, such as the web disclosed in U.S. Pat. No. 3,660,186, a significant degree of adhesive and/or aqueous solution (usually water, or an oil and water mixture) was still required as a bonding medium to assist in the formation of hydrogen bonds to provide the level of lamination required to bond the materials together.

Accordingly, a method and apparatus for producing a fibrous cellulosic web with required levels of ply attachment via ultrasound energy while simultaneously imparting a consistent and distinct pattern to the web without significantly degrading the desired physical attributes would be desirable. Moreover, such methods and apparatus which did not require the use of conventional mechanical crimping wheels, adhesives, or fluids to moisten the web prior to bonding, or equipment to dry the web after application of fluids would likewise be desirable.

Definitions

As used herein, the term “cellulosic material” refers to material that may be prepared from cellulose fibers from synthetic sources or natural sources, such as woody and non-woody plants. Woody plants include, for example, deciduous and coniferous trees. Non-woody plants include, for example, cotton, flax, esparto grass, milkweed, straw, jute, hemp, and begasse. The cellulose fibers may be modified by various treatments such as, for example, thermal, chemical, and/or mechanical treatments. It is contemplated that reconstituted and/or synthetic cellulose fibers maybe used and/or blended with other cellulose fibers of the fibrous cellulosic material

As used herein, the term “pulp” refers to cellulosic fibrous material from sources such as woody and non-woody plants. Woody plants include, for example, deciduous and coniferous trees. Non-woody plants include, for example, cotton, flax, esparto grass, milkweed, straw, jute, hemp, and bagasse. Pulp may be modified by various treatments such as, for example, thermal, chemical and/or mechanical treatments.

As used herein, the term “spunbond or “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., and U.S. Pat. No. 5,382,400 to Pike et al.

As used herein the term “nonwoven fabric” or “non-woven web” means a web having a structure of individual fibers or threads which are interlaid, but not in an identifiable manner as in a knitted fabric. The basis weight of nonwoven fabrics is usually expressed in ounces of material per square yard (osy) or grams per square meter (gsm).

As used herein, the term “hydroentangled” with reference to a fibrous web or substrate means the web or substrate has been subjected to a hydraulic entangling or similar procedure whereby streams or jets of a fluid are employed to entangle the fibers in the fibrous web or substrate. Such jets of fluid orient and entangle fibers in the Z direction, i.e., through the thickness of the web or substrate. Where a jet impinges the web or substrate, a distinct hole or depression is formed which represent a locus of fiber entanglement. For convenience, these jet impingement sites, or loci, are referred to collectively hereinafter as “entanglement loci.” For example, hydraulic entangling may be accomplished by means of conventional hydraulic entangling equipment, such as that described in U.S. Pat. No. 3,485,706 to Evans, which is incorporated herein by reference. Another hydroentangling process which may be employed is described in U.S. Pat. No. 4,144,370 to Bouolton which also is incorporated herein by reference. See also U.S. Pat. Nos. 4,931,355 and 4,879,170 to Radwanski et al., and U.S. Pat. Nos. 4,808,467 to Suskind et al., 4,612,226 to Kennette et. al., and 5,284,703 to Everhart et al., each of which is incorporated herein by reference.

As used herein, the term “basis weight” (hereinafter may be referred to as “BW”) is the weight per unit area of a sample and may be reported as grams per meter squared (gsm). The basis weight may be measured using test procedure ASTM D 3776-96 or TAPPI Test Method T-220.

As used herein, the term “Peel Test” refers to testing a laminate for the amount of tensile force which will pull the layers of the laminate apart. The peel test used in the present examples is identical to ASTM Standard Test D 2724.13 and to Method 5951, Federal Test Methods Standard 191 A, except that: (a) the specimen size is 2 in.×6 in.; (b) the gauge length is 1.0 in.; and (c) the value peak load alone is defined as the bond strength of the specimen. The bond strength of the sample unit is calculated as the average peak load of all the specimens tested. However, in both the Federal and ASTM procedures, the bond strength of each individual specimen is calculated as the average of the five highest and the five lowest peaks recorded for that specimen. Therefore, in the Federal and ASTM methods, the bond strength of the sample unit is the average of the calculated bond strengths of all the specimens tested. The specimen is tested, for example, using an Instron Model TM, available from the Instron Corporation, 2500 Washington St., Canton, Mass. 02021, or a Thwing-Albert Model INTELLECT II, available from the Thwing-Albert Instrument Co., 10960 Dutton Rd., Philadelphia, Pa. 19154.

### SUMMARY OF THE INVENTION

In one aspect of the invention, a method of simultaneously laminating and imprinting a pattern on a web formed substantially from cellulosic material is provided. At least two plies or layers of cellulosic material are provided. The two plies are superposed, and passed between an ultrasonic bonder and a patterned anvil roll to simultaneously produce bonded and patterned areas over the superposed plies without first applying a bonding medium on the plies.

In another aspect of the invention, a method of simultaneously laminating and imprinting a pattern on a web formed from cellulosic material is provided. At least two plies of substantially dry cellulosic material is provided. The at least two plies are superposed, and the substantially dry combined plies are passed between an ultrsonic bonder and a patterned anvil roll to simultaneously produce bonded and patterned areas over the superposed plies

In yet another aspect of the invention, a method of simultaneously laminating and providing patterned perforations in a web formed from cellulosic material is provided. At least two plies of substantially dry cellulosic material is provided. The two plies are superposed, and the substantially dry combined plies are passed between an ultrasonic bonder and a patterned anvil roll to simultaneously produce bonded areas and patterned perforations over the superposed plies.

### BRIEF DESCRIPTION OF THE DRAWINGS

FIG. 1 is a schematic illustration of a process for producing a two ply or multi-component layer ultrasonically bonded and pattern imprinted cellulosic web or primarily cellulosic web in accordance with the present invention:

FIG. 2 is a schematic illustration, not necessarily to scale, of a floral vine pattern used in ultrasonic imprinting; and

FIG. 3 is a scematic illustration, not necessarily to scale, of a zigzag pattern used in ultrasonic imprinting.

### DETAILED DESCRIPTION

While the invention will be described in connection with preferred embodiments, it will be understood that it is not intended to limit the invention to these embodiments. On the contrary, it is intended to cover all alternatives, modifications, and equivalents as may be included within the spirit and scope of the invention as defined by the appended claims. Furthermore, as used herein, the term “comprises” or “comprising” is inclusive or open-ended and does not exclude additional unrecited elements, compositional components, or method steps. Accordingly, the term “comprising” encompasses the more restrictive terms “consisting essentially of” and “consisting of.”

The present invention is useful with cellulosic webs, i.e., webs which are substantially 100% cellulose. Such cellulosic webs are known are known in the art; for example, but not by way of limitation, methods of making creped cellulosic webs is known in the art, and one method is disclosed, for example, in U.S. Pat. No. U.S. Pat. No. 6,027,611 to McFarland et al., which is hereby incorporated by reference herein. Methods of making uncreped throughdried sheet material are disclosed in U.S. Pat. No. 5,591,309 to Rugowski et al., U.S. Pat. No. 5,399,412 to Sudall et al., and U.S. Pat. No. 5,048,589 to Cook et al., all of which are also hereby incorporated by reference herein.

The present invention is also useful in simultaneously bonding and forming a pattern by using ultrasonic equipment on webs which are formed primarily from cellulose, which are, for example, but not by way of limitation, at least about 70% cellulose. In one example, a cellulosic/spunbond hydroentangled web is about 80% cellulose and about 20% spunbonded material. Such a web is disclosed in U.S. Pat. Nos. 5,389,202 and 5,284,703, both to Everhart et al., and both of which are hereby incorporated by reference herein in there entirety.

Previously, to attempt bonding or ply attachment of about 100% cellulosic material, or a cellulosic/synthetic laminate, a liquid, often an aqueous solution, an adhesive/aqueous mixture, an oil and water solution, or a solution of alcohol(s) or mixtures of alcohol(s) and water were required, as disclosed in U.S. Pat. Nos. 4,605,454, and 3,660,186. Additional equipment was required to hold and spray the solution(s) on the web(s) prior to ultrasonic bonding, to prevent burning of the webs. A drier was also required to dry the bonded web after it passed the ultrasonic horn. Damage to the webs by burning, as well as the requirement of additional wetting solutions and equipment, have previously made ultrasonic bonding of cellulosic webs unsuccessful as a commercial product. The present invention requires no wetting of the cellulosic or cellulosic/spunbond web. Bonding mediums have been taught that include an aqueous solution, it may also, or alternatively, include an adhesive mixture, or, in another alternative, it may include an oil and water solution, and, in yet another alternative, it may include a solution of alcohol(s) or mixtures of alcohol(s) and water.

Vibrational ultrasonic bonders are commercially available, for example, from Dukane Corporation, St. Charles, Ill., and any of a wide variety of specific models may be used in the process of the invention. The useful range of frequencies is very wide. Frequencies of up to about 40 kHz and about 20 kHz are often used commercially. Frequencies of, for example, 18 kHz and as low as 10 kHz have also been used. The power settings often used commercially are 1000 watts and 700 watts, although other power settings may be utilized. Desirably, the pressure setting for the ultrasonic horn is in the range of about 1 psi to about 100 psi. More desirably, the pressure setting is in the range of about 2 psi to about 70 psi, and in yet more desirably, the range is about 3 psi to about 60 psi.

The particular pattern used for the anvil roll involves largely a matter of choice, depending upon the physical properties desired in the web product. However, the height and spacing of the projections will be selected in accordance with the desired end product. For example, the height will preferably be at least about the thickness of the formed web and the projections will preferably be spaced sufficiently to provide substantial lamination of the two or more plies. The projections, themselves, may be of any desired shape, but will generally occupy about 3 to about 25% of the surface area and, often, about 5 to about 15%, depending on the desired end use.

Various bond patterns have been developed for functional as well as aesthetic reasons. In this regard, the layers are desirably bonded over less than the entire surface area of the fabric using an intermittent or spaced pattern of bond areas. Desirably, the bond area is between about 2% and about 30% of the surface area of the web and still more desirably between about 4% and about 15% of the web. Still further, the bonding pattern desirably employs a pattern comprising a plurality of spaced, repeating bond segments. By way of non-limiting example, various bonding patterns are disclosed in U.S. Pat. Nos. 4,374,888; 3,855,046; 5,635,134; D247,370; D247,371; D433,131; D433,132; D437,489; and D450,190, the entire contents of each of the aforesaid references are hereby incorporated herein by reference.

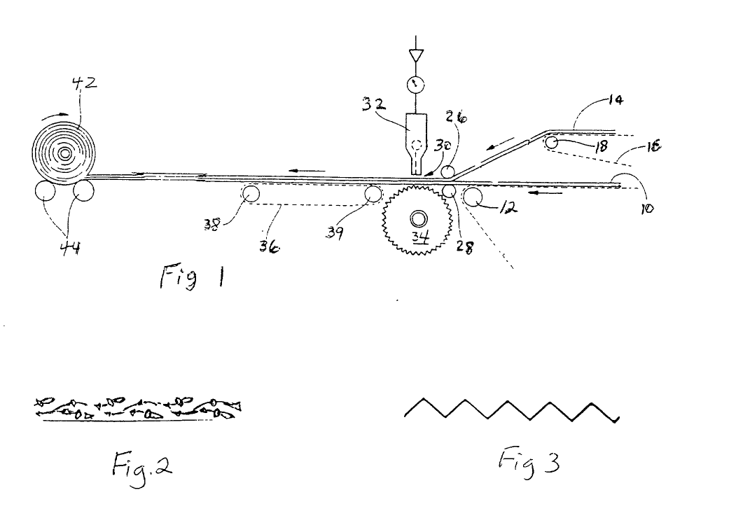

Turning to FIG. 1, first ply or layer 10 is directed over feed roll 12 while second ply or layer 14 is directed on support wire 16 over feed roll 18 separated from feed roll 12. The first and second ply 10,14 are then lightly compacted between rolls 26 and 28 and directed to nip 30 between ultrasonic bonder or horn 32 and patterned anvil bonding roll 34. After bonding, the combined web may be directed over wire 36 supported by one or more rolls 38, 39 to be rolled into parent roll 42 on support rolls 44 or directed to further converting or product manufacturing steps.

While only two layers 10, 14 are illustrated as being bonded and simultaneously ultrasonically imprinted with a pattern, additional plies or layers may be bonded, for example, in the manner illustrated in FIG. 2 of U.S. Pat. No. 4,605,454, hereby incorporated by reference herein.

In one embodiment, the speed of the web is at least about 40 ft/min (12.2 m/min) or more. In an alternative embodiment, the speed of the web is at least about 65 ft/min (19.8 m/min). It is contemplated that greater speeds may be utilized as well.

The process of the present invention is adapted to produce both relatively light basis weight cellulose laminates and relatively heavy basis weight cellulose laminates. The webs (single ply), such as towels produced from about 100% cellulosic material desirably have a dry basis weight in a range of about 3 gsm to about 50 gsm, and, more desirably, in a range of about 5 gsm to about 40 gsm. Even more desirably, the webs produced from about 100% cellulosic material have a dry basis weight of about 20 gsm to about 35 gsm.

Webs (single ply) such as tissues produced from about 100% cellulosic material desirably have a dry basis weight in a range of about in a range of about 3 gsm to about 35 gsm, and, more desirably, in a range of about 5 gsm to about 20 gsm. Even more desirably, the webs produced from about 100% cellulosic material have a dry basis weight of about 7 gsm to about 19 gsm.

Webs produced from an about 80% cellulosic and about 20% spunbond material (single ply) desirably have a dry basis weight in a range of about 20 gsm to about 300 gsm, and, more desirably, in a range of about 30 gsm to about 200 gsm. Further, the referenced webs even more desirably have a dry basis weight of about 50 gsm to about 180 gsm, and yet still more desirably, a dry basis weight of about 60 gsm to about 110 gsm.

The basis weight of the laminates produced depend upon the particular end use. The number of layers is not critical and will vary depending on the end use and equipment configuration.

When towels were simultaneously ultrasonically imprinted with a pattern and bonded together using ultrasonic energy, the simultaneous bonding/patterned imprinting of the plies was often conducted using, desirably, pressures of about 5 psi to about 26 psi, and more desirably, pressures of about 7 psi to about 25 psi, and even more desirably, pressures of about 10 psi to about 20 psi. The towels were simultaneously bonded and perforated with patterned perforations using pressures, desirably, of about 28 psi to about 60 psi, and more desirably at pressures of about 29 psi to about 50 psi, and even more desirably at pressures of about 30 psi to about 45 psi. Simultaneous bonding/patterned imprinting on towels occurs more readily when a diffuse pattern, such as, for example, but not by way of limitation, a floral vine pattern is utilized at lower pressures. A similar floral vine pattern is illustrated schematically in FIG. 2. Simultaneous bonding and patterned perforations on towels occur more readily when a thicker, more focused, less diffuse pattern, such as a zigzag pattern, was utilized at higher pressures. A similar zigzag pattern is shown schematically in FIG. 3.

Diffuse patterns, such as the floral vine pattern, are patterns which have may have relatively many thin lines to the pattern, as illustrated in FIG. 2. Focused patterns, such as the zigzag pattern, are patterns which may have relatively few lines which are thick lines, as illustrated in FIG. 3.

As used herein, “perforations” or “slits” refers to a patterned opening formed in at least a two ply web, each ply being substantially bonded at or near the edges of the patterned opening.

When tissues were simultaneously imprinted and bonded together using ultrasonic energy, the simultaneous bonding/patterned imprinting of the plies was conducted using a diffuse pattern on the patterned anvil bonding roll, such as, for example, the floral vine pattern, similar to the pattern illustrated in FIG. 2, along with pressures desirably of about 10 psi to about 60 psi, and more desirably pressures of about 20 psi to about 55 psi, and even more desirably pressures of about 30 psi to about 50 psi. When tissues were simultaneously bonded and perforated with patterned perforations, the simultaneous bonding/patterned perforating of the plies was often conducted using a thicker, more focused, less diffuse pattern, such as, for example, a zigzag pattern, similar to the pattern shown in FIG. 3, desirably at pressures of about 10 psi to about 60 psi, and more desirably at pressures of about 20 psi to about 55 psi, and even more desirably at pressures of about 30 psi to about 50 psi.

When cellulosic/spunbond rags were simultaneously imprinted and bonded together using ultrasonic energy, the simultaneous bonding/patterned imprinting of the plies was often conducted using pressures desirably of about 1 psi to about 60 psi, and more desirably pressures of about 5 psi to about 50 psi. The rags were simultaneously bonded and perforated with patterned perforations at pressures desirably of about 12 psi to about 60 psi, and more desirably at pressures of about 15 psi to about 50 psi. Simultaneous bonding/patterned imprinting on cellulosic/spunbond rags occurs more readily when a diffuse pattern, such as, for example, but not by way of limitation, a floral vine pattern (FIG. 2), is utilized. Simultaneous bonding and patterned perforations on rags occur more readily when a thicker, more focused, less diffuse pattern, such as a zigzag pattern (FIG. 3), is used.

When bonding towels, tissues, and rags, the ultrasonic energy frequently applied was 20 kHZ/1000 Watts. Ultrasonic energy also may also be applied at, for example, 40 kHZ/700 Watts; other combinations of kHz/Watts may also be used.

All plies of all towels, tissues, and rags, desirably have a moisture content of less than about 2%. Further, all plies of all towels, tissues, and rags, more desirably, have a moisture content of less than about 1%. Moreover, all plies of all towels, tissues, and rags even more desirably may have a moisture content of less than about 0.5%.

The process produces, under the conditions disclosed in the examples provided below, uniform webs which are physically bonded as well as imprinted with a pattern. The process occurs without use of a bonding medium, and results in no burning of the web, good ply bonding or attachment of the web, and good imprinted patterns to the web. Therefore, a process for laminating cellulosic material while simultaneously imprinting patterns on the material, and substantially reducing or eliminating liquid(s) such as bonding mediums and the additional equipment to provide such liquid(s) and bonding medium, as well as eliminating equipment to dry the web, has been provided.

The process, using a very focused, non-diffuse pattern, such as a zigzag pattern, usually at higher pressure settings, produced well defined slits as well as bonding in the web. The process, under the conditions disclosed in the examples below, may provide bonded webs having patterned perforations, without burning or otherwise impairing the webs, or requiring additional materials or equipment.

The process of the invention will now be further illustrated by specific examples.

### EXAMPLE 1

### EXAMPLE 1A

A substantially 100% cellulose two ply web was formed using two one-ply webs. Each one ply web had a basis weight of approximately 30 gsm, and each one ply web was tested at least 15 days after manufacture. The webs are towels available from Kimberly-Clark Corporation under the trademark SCOTT®. The webs are uncreped throughdried sheet material and were formed generally in the manner disclosed in U.S. Pat. No. 5,591,309 to Rugowski et al., U.S. Pat. No. 5,399,412 to Sudall et al., and U.S. Pat. No. 5,048,589 to Cook et al., which all have been previously incorporated by reference herein.

The two single ply webs were hand cut and superposed simultaneously and hand-directed to the ultrasonic horn 32 and patterned anvil roll 34. The two plies were lightly compacted and directed to a nip 30 between the ultrasonic horn 32 and a patterned anvil roll 34. Thereafter, the combined plies were removed after passing through the nip 30.

Ultrasonic energy was applied to at 20 kHZ/1000 Watts with a horn pressure against the patterned anvil roll of 10 psi. The pattern used was a floral vine pattern, which was similar to the pattern illustrated in FIG. 2. Individual bond locations on the laminate material may have a surface area ranging from about 0.1 cm² to about 0.3 cm². As disclosed in Table 1, the Peak Load was 7.6 gm; the Average Load was not calculated. Using the floral vine pattern, ply attachment was well achieved.

### EXAMPLE 1B

A substantially 100% cellulose two ply web was formed using two one ply webs. Each web had the same characteristics, was provided under the same conditions, and used exactly the same method as described in Example 1A, except that 20 psi ultrasonic horn pressure was used.

As disclosed in Table 1, the Peak Load was 9.8 gm; the Average Load was not calculated. Using the floral vine pattern, ply attachment was well achieved.

### EXAMPLE 1C

A substantially 100% cellulose two ply web was formed using two one ply webs. Each web had the same characteristics, was provided under the same conditions, and used exactly the same method as described in Example 1A, except that 40 psi ultrasonic horn pressure was used.

As disclosed in Table 1, the Peak Load was 13.5 gm; the Average Load was 4.2 gm. Using the floral vine pattern, the anvil began cutting through the web at 40 psi. Using a zigzag pattern at 40 psi resulted in slitting or perforating the web without damage (burning) to the surrounding web.

TABLE 1

| Example: | 1A | 1B | 1C |
|---|---|---|---|
| Description: | Towel | Towel | Towel |
| (one ply) | | | |
| Material | 100% Cellulose | 100% Cellulose | 100% Cellulose |
| Content: | | | |
| Pressure | 10 | 20 | 40 |
| Setting (psi): | | | |
| Basis | 30 | 30 | 30 |
| Weight (per ply) | | | |
| (gsm): | | | |
| Peel Test: | 7.6 | 9.8 | 13.5 |
| Peak Load (gm) | N/P* | 2.2 | 4.2 |
| Average Load (gm) | | | |

N/P* = not performed

Using the towels and process parameters described in Examples 1A-1C and Table 1, the imprinted patterning was well defined and the bonding of the plies was sufficient at about 10 to 20 psi. At 30 to 40 psi, the anvil created uneven cuts through the plies using the diffuse floral vine pattern. Using a less diffuse pattern, namely, a zigzag pattern, at pressures to 30 to 40 psi resulted in well defined patterned perforations/patterned slits and bonding.

### EXAMPLE 2

### EXAMPLE 2A

A 100% cellulose two ply web was formed using one web having two plies, and first separating the web into two one ply webs. The basis weight of each ply was approximately 13 gsm and the basis weight of the combined two ply web was approximately 27 gsm. Each web was tested at least 15 days after manufacture. The webs are commercial facial tissue available from Kimberly-Clark Corporation under the trademark KLEENEX®.

Each of the one ply webs was superposed simultaneously and hand-directed to the ultrasonic horn 32 and patterned anvil roll 34. The two plies were lightly compacted and directed to a nip 30 between the ultrasonic horn 32 and a patterned anvil roll 34. Thereafter, the combined plies were removed after passing through the nip 30.

Ultrasonic energy was applied to at 20 kHZ/1000 Watts with a horn pressure against the patterned anvil roll of 30 psi. The pattern used was a floral vine pattern, similar to the pattern illustrated in FIG. 2. Individual bond locations on the laminate material may have a surface area ranging from about 0.1 cm² to about 0.3 cm². As 5 disclosed in Table 2, the Peak Load was 3.2 gm; the Average Load was 1.0 gm. Using the floral vine pattern, ply attachment was well achieved.

### EXAMPLE 2B

A 100% cellulose two ply web was formed using two one ply webs. Each web had the same characteristics, was provided under the same conditions, and used exactly the same method as described in Example 2A, except that 40 psi ultrasonic horn pressure was used.

As disclosed in Table 2, the Peak Load was 3.2 gm; the Average Load was 1.2 gm. Using the floral vine pattern, ply attachment was well achieved

### EXAMPLE 2C

A 100% cellulose two ply web was formed using two one ply webs. Each web had the same characteristics, was provided under the same conditions, and used exactly the same method as described in Example 2A, except that 50 psi ultrasonic horn pressure 20 was used.

As disclosed in Table 2, the Peak Load was 3.2 gm; the Average Load was not calculated. Using the floral vine pattern, ply attachment was well achieved.

### EXAMPLE 2D

A 100% cellulose two ply web was formed using two one ply webs. Each web had the same characteristics, was provided under the same conditions, and used exactly the same method as described in Example 2A, except that 20 psi ultrasonic horn pressure was used.

As disclosed in Table 2, the Peak Load was 2.1 gm; the Average Load was not calculated. Using the floral vine pattern, ply attachment was only moderately achieved.

### EXAMPLE 2E

A 100% cellulose two ply web was formed using two one ply webs. Each web had the same characteristics, was provided under the same conditions, and used exactly the same method as described in Example 2A, except that 10 psi ultrasonic horn pressure was used.

As disclosed in Table 2, the Peak Load was 2.1 gm; the Average Load was 0.6 gm. Using the floral vine pattern, ply attachment was poorly achieved.

### EXAMPLE 2F

A 100% cellulose two ply web was formed using two one ply webs. Each web had the same characteristics, was provided under the same conditions, and used exactly the same method as described in Example 2A, except that 5 psi ultrasonic horn pressure was used.

As disclosed in Table 2, the Peak Load was 2.1 gm; the Average Load was 0.6 gm. Using the floral vine pattern, ply attachment was poorly achieved.

### EXAMPLE 2G (COMPARISON)

A 100% cellulose two ply web was formed using two one ply webs, having the same characteristics, and provided under the same conditions, as described in Example 2A, except that the two plies were passed over crimping wheels, in a manner described in, for example, U.S. Pat. Nos. 5,698,291, 5,622,734, and 5,543,202, which are all hereby incorporated by reference herein, to provide a control reference of bonding for comparison with Peel Test results.

As disclosed in Table 2, the Peak Load was 3.9 gm; the Average Load was 1.1 gm. Ply attachment was well achieved.

TABLE 2

| | | | | | | | 2G |
|---|---|---|---|---|---|---|---|
| Example: | 2A | 2B | 2C | 2D | 2E | 2F | (Comparison) |
| Description: | Tissue | Tissue | Tissue | Tissue | Tissue | Tissue | Tissue |
| Material | 100% | 100% | 100% | 100% | 100% | 100% | 100% |
| Content: | Cellulose | Cellulose | Cellulose | Cellulose | Cellulose | Cellulose | Cellulose |
| Pressure | 30 | 40 | 50 | 20 | 10 | 5 | *Wheels |
| Setting (psi): | | | | | | | |
| Basis | 13 | 13 | 13 | 13 | 13 | 13 | 13 |
| Weight (per ply) | | | | | | | |
| (gsm): | | | | | | | |
| Peel Test: | 3.2 | 3.2 | 3.2 | 2.1 | 2.1 | 2.1 | 3.9 |
| Peak Load (gm) | | | | | | | |
| Average Load (gm) | 1.0 | 1.2 | N/P** | N/P** | 0.6 | 0.6 | 1.1 |

*Wheels = bonding wheels
N/P** = Not Perfomed

Using the tissues and process parameters described in Examples 2A-2F and Table 2, the patterning and bonding of the plies was optimal, i.e., the pattern was well defined and the bond was sufficient, at about 30 psi to about 50 psi using the diffuse floral vine pattern, although bonds and patterns were obtained at lower pressures (20 psi) as well. At 30 to 50 psi, using a less diffuse and more focused pattern, namely, a zigzag pattern, well defined patterned perforations/patterned slits and bonding were provided in the tissue.

### EXAMPLE 3

### EXAMPLE 3A

A 100% cellulose two ply web was formed using two one-ply webs. Each one ply web had a basis weight of about 80 gsm, and each one ply web was tested at least 15 days after manufacture. The webs are hydroentangled pulp and spunbond material (about 80% cellulosic pulp) available from Kimberly-Clark Corporation under the trademark HYDROKNIT® WORKHORSE Rags. Such fabrics and their manufacture are described in U.S. Pat. Nos. 5,284,703, and 5,389,202, both to Everhart et al., which have been previously incorporated herein by reference herein in its entirety.

The two single ply webs were superposed simultaneously and hand-directed to the ultrasonic horn 32 and patterned anvil roll 34. The two plies were lightly compacted and directed to a nip 30 between the ultrasonic horn 32 and a patterned anvil roll 34.

Thereafter, the combined plies were removed after passing through the nip 30.

Ultrasonic energy was applied to at 20 kHZ/1000 Watts with a horn pressure against the patterned anvil roll of 50 psi. The pattern used was a zigzag pattern, similar to the pattern illustrated in FIG. 3. Individual bond locations on the laminate material may have a surface area ranging from about 0.1 cm² to about 0.3 cm². As disclosed in Table 3, the Peak Load was 1255.0; the Average Load was not calculated. Using the zigzag pattern, ply attachment was well achieved.

### EXAMPLE 3B

An 80% cellulose 20% spunbond two ply web was formed using two one ply webs. Each web had the same characteristics, was provided under the same conditions, and used exactly the same method as described in Example 3A, except that 5 psi ultrasonic horn pressure was used.

As disclosed in Table 3, the Peak Load was 103.0 gm; the Average Load was not calculated. Using the zigzag pattern, ply attachment was well achieved.

TABLE 3

| Example: | 3A | 3B |
|---|---|---|
| Description: | Rag | Rag |
| (one ply) | | |
| Material | 80% Cellulose/20% | 80% Cellulose/20% |
| Content: | Spunbond Fibers | Spunbond Fibers |
| Pressure | 50 | 5 |
| Setting (psi): | | |
| Basis | 80.0 | 80.0 |
| Weight (per ply) | | |
| (gsm): | | |
| Peel Test: | 1255.0 | 103.0 |
| Peak Load (gm) | | |
| Average Load (gm) | N/P* | N/P* |

N/P* = not performed

Using the rags and the process parameters described in Examples 3A and3B and Table 3, the imprinted patterning and bonding of the plies were obtained at about 5 psi to about 50 psi using the diffuse floral vine pattern. At about 15 to about 50 psi, using a less diffuse and more focused pattern, namely, a zigzag pattern, well defined and patterned perforations/patterned slits and bonding were provided in the bonded rags.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations that fall within the spirit and broad scope of the appended claims.

What is claimed is:

1. A method of simultaneously laminating and imprinting a pattern on a web formed from cellulosic material, the method comprising the steps of:
providing at least two plies of cellulosic material;
superposing the at least two plies;
passing the superposed plies between an ultrasonic bonder and a patterned anvil roll to simultaneously produce bonded and patterned areas over the superposed plies without first applying a bonding medium to the plies.

2. The method of claim 1 wherein the cellulosic material is at least about 100% cellulose.

3. The method of claim 2, wherein the cellusose is further defined as pulp.

4. The method of claim 1, wherein the cellulosic material comprises a basis weight between about 5 gsm and about 40 gsm per ply.

5. The method of claim 4, wherein the cellulosic material comprises a basis weight between about 20 gsm and about 35 gsm per ply.

6. The method of claim 4, wherein the pressure of the ultrasonic bonder against the patterned anvil roll is between about 5 psi to about 26 psi.

7. The method of claim 6, wherein the pressure of the ultrasonic bonder against the patterned anvil roll is between about 10 psi to about 20 psi.

8. The method of claim 6, wherein the ultrasonic energy applied to the combined plies is about 20 kHZ and about 1000 Watts.

9. The method of claim 1, wherein the cellulosic material comprises a basis weight of about 5 gsm to about 20 gsm per ply.

10. The method of claim 9, wherein the cellulosic material comprises a basis weight of about 7 gsm to about 19 gsm.

11. The method of claim 9, wherein the pressure of the ultrasonic bonder against the patterned anvil roll is between about 10 psi to about 60 psi.

12. The method of claim 11, wherein the pressure of the ultrasonic bonder against the patterned anvil roll is between about 30 psi to about 50 psi.

13. The method of claim 11, wherein the ultrasonic energy applied to the combined plies is about 20 kHZ and about 1000 Watts.

14. The method of claim 1, wherein the cellulosic material includes at least about 80% cellulose.

15. The method of claim 14, wherein the basis weight of the material is about 60 gsm to about 110 gsm per ply.

16. The method of claim 15, wherein the pressure of the ultrasonic bonder against the patterned anvil roll is between about 1 psi to about 60 psi.

17. The method of claim 16, wherein the pressure of the ultrasonic bonder against the patterned anvil roll is between about 10 psi to about 50 psi.

18. The method of claim 15, wherein the ultrasonic energy applied to the combined plies is about 20 kHZ and about 1000 Watts.

19. The method of claim 1, wherein immediately after the plies pass through a nip formed by the ultrasonic bonder and patterned anvil roll, the plies have less than a 2% moisture content.

20. The method of claim 19, wherein immediately after the plies pass through a nip formed by the ultrasonic bonder and patterned anvil roll, the plies have less than a 0.5% moisture content.

21. A method of simultaneously laminating and imprinting a pattern on a web formed from cellulosic material, the method comprising the steps of:
providing at least two plies of substantially dry cellulosic material;
superposing the at least two plies together;
passing the substantially dry superposed plies between an ultrasonic bonder and a patterned anvil roll to simultaneously produce substantially patterned and bonded areas over the superposed plies.

22. The method of claim 21 wherein each ply has less than 2% moisture content.

23. The method of claim 21, wherein the cellulosic material is about 100% cellulose.

24. The method of claim 23, wherein the cellulosic material comprises pulp.

25. The method of claim 21, wherein the cellulosic material comprises a basis weight between about 20 gsm and about 35 gsm per ply.

26. The method of claim 25, wherein the pressure of the ultrasonic bonder against the patterned anvil roll is between about 5 psi to about 26 psi and the ultrasonic energy applied to the combined plies is about 20 kHZ and about 1000 Watts.

27. The method of claim 21, wherein the cellulosic material comprises a basis weight of about 7 gsm to about 19 gsm.

28. The method of claim 27, wherein the pressure of the ultrasonic bonder against the patterned anvil roll is between about 10 psi to about 60 psi and the ultrasonic energy applied to the combined plies is about 20 kHZ and about 1000 Watts.

29. The method of claim 21 wherein the cellulosic material includes at least about 80% cellulose and the basis weight of the material is about 60 gsm to about 110 gsm per ply.

30. The method of claim 29, wherein the pressure of the ultrasonic bonder against the patterned anvil roll is between about 1 psi to about 60 psi and the ultrasonic energy applied to the combined plies is about 20 kHZ and about 1000 Watts.

31. A method of simultaneously laminating and providing patterned perforations in a web formed from cellulosic material, the method comprising the steps of:
providing at least two plies of substantially dry cellulosic material;
superposing the at least two plies;
passing the substantially dry superposed plies between an ultrasonic bonder and a patterned anvil roll to simultaneously produce bonded areas and patterned perforations over the superposed plies.

32. The method of claim 31 wherein each ply has less than 2% moisture content.

33. The method of claim 31, wherein the cellulosic material is about 100% cellulose.

34. The method of claim 33, wherein the cellulosic material comprises pulp.

35. The method of claim 31, wherein the cellulosic material comprises a basis weight between about 20 gsm and about 35 gsm per ply.

36. The method of claim 35, wherein the pressure of the ultrasonic bonder against the patterned anvil roll is between about 28 psi to about 60 psi.

37. The method of claim 36, wherein the ultrasonic energy applied to the combined plies is about 20 kHZ and about 1000 Watts.

38. The method of claim 31, wherein the cellulosic material comprises a basis weight of about 7 gsm to about 19 gsm.

39. The method of claim 38, wherein the pressure of the ultrasonic bonder against the patterned anvil roll is between about 10 psi to about 60 psi.

40. The method of claim 39, wherein the ultrasonic energy applied to the combined plies is about 20 kHZ and about 1000 Watts.

41. The method of claim 31 wherein the cellulosic material includes at least about 80% cellulose and the basis weight of the material is about 60 gsm to about 110 gsm per ply.

42. The method of claim 41, wherein the pressure of the ultrasonic bonder against the patterned anvil roll is between about 12 psi to about 60 psi.

43. The method of claim 42, wherein the ultrasonic energy applied to the combined plies is about 20 kHZ and about 1000 Watts.
